(19) United States
(12) Patent Application Publication
(10) Pub. No.: US 2010/0303376 A1
(43) Pub. Date: Dec. 2, 2010

(54) CIRCUIT AND METHOD FOR PROCESSING IMAGE

(75) Inventors: Wei-Fu Chen, Taipei County (TW); Chih-Chia Kuo, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 12/606,187

(22) Filed: Oct. 27, 2009

(30) Foreign Application Priority Data
Jun. 2, 2009 (TW) 98118207

(51) Int. Cl. G06K 9/40

(52) U.S. Cl. 382/263

(57) ABSTRACT

A circuit and a method for processing an image are provided. The circuit includes a weighting circuit and a sharpening circuit. The weighting circuit includes at least two adapters and a weight decider. The weighting circuit receives an input image. Each of the adapters respectively generates a weight according to an image property of the input image. The weight decider performs a logical calculation according to the weights generated by the adapters to generate a total weight. The sharpening circuit performs an image sharpening process on the input image according to the total weight to generate an output image.

### CROSS-REFERENCE TO RELATED APPLICATION

This application claims the priority benefit of Taiwan application serial no. 98118207, filed on Jun. 2, 2009. The entirety of the above-mentioned patent application is hereby incorporated by reference herein and made a part of specification.

### BACKGROUND OF THE INVENTION

1. Field of the Invention

The present invention generally relates to a circuit and a method for processing an image, and more particularly, to a circuit and a method for sharpening an image according to a plurality of image properties.

2. Description of Related Art

While looking at an image, one can easily notice the different colors and tones in the image. An image usually contains different image objects, and each of the image objects is composed of a plurality of pixels having the same or similar color information. Generally speaking, an image attracts more attention if vivid contrasts exist between adjacent image objects in the image. The term “sharpness” usually refers to the contrast between image objects, and in order to enhance the visual effect of an image, sharpening techniques are usually adopted to increase the sharpness of the image.

A video signal processing apparatus 100, as shown in FIG. 1, is disclosed in U.S. Patent No. 2005/0270425. Referring to FIG. 1, the video signal processing apparatus 100 receives an input video signal S_{A} and generates an output video signal S_{D} after performing an sharpening operation on the input video signal S_{A}. FIGS. 2A-2E show timing diagrams of some signals of the video signal processing apparatus 100 in FIG. 1. Referring to FIG. 2A, the input video signal S_{A} includes a general video signal S and noises n₁ and n₂, wherein the general video signal S carries the image information. The video signal processing apparatus 100 improves the sharpness of the general video signal S and avoids doing so to the noises n₁ and n₂.

The video signal processing apparatus 100 includes a signal delayer 101, a weighting unit 103, a first multiplier 109, a second multiplier 111, an adder 113, and a high-pass filter 115. Referring to FIG. 1 and FIG. 2B, the high-pass filter 115 receives the input video signal S_{A} and performs a high-pass filtering process on the input video signal S_{A} to generate a high-frequency signal S_{B}.

Referring to FIG. 1 and FIG. 2C, the weighting unit 103 includes an edge calculator 105 and a weight calculator 107. The edge calculator 105 receives the input video signal S_{A} and detects the image information thereof, and the edge calculator 105 calculates the color information difference between a current pixel and adjacent pixels to determine whether the current pixel is located at an edge of the image. The weight calculator 107 generates a weighted signal S₁ according to foregoing determination result.

The weighted signal S₁ is adjusted according to a gain S₂. The first multiplier 109 multiplies the weighted signal S₁ by the gain S₂ to generate a total weight S₃. Referring to FIG. 1 and FIG. 2D, the second multiplier 111 multiples the total weight S₃ by the high-frequency signal S_{B} to generate an accumulated signal S_{C}. Meanwhile, the signal delayer 101 delays the input video signal S_{A} and outputs a delayed video signal S₄ to the adder 113. Referring to FIG. 1 and FIG. 2E, the adder 113 adds the delayed video signal S₄ to the accumulated signal S_{C} to generate an output video signal S_{D}. By now, the sharpening process is completed. The output video signal S_{D} contains a video signal S′ and the noises n₁ and n₂, wherein the video signal S′ is the sharpened general video signal S.

Generally speaking, the color information of a pixel comprises many properties, such as brightness and chrominance. However, the video signal processing apparatus 100 only sharpens the input video signal S_{A} regarding a single property thereof. Thus, the video signal processing apparatus 100 cannot perform an adaptive sharpening process on the input video signal S_{A} according to different image properties thereof.

### SUMMARY OF THE INVENTION

Accordingly, the present invention is directed to a circuit and a method for processing an image, wherein a plurality of weights is generated according to at least one image property of a plurality of pixels of the image, and an image sharpening process is performed on the image according to these weights.

The present invention provides an image processing circuit including a weighting circuit and a sharpening circuit. The weighting circuit includes a first adapter, a second adapter, and a weight decider. The first adapter receives an input image and generates a first weight according to a first image property of the input image. The second adapter receives the input image and generates a second weight according to a second image property of the input image. The weight decider is coupled to the first adapter and the second adapter and generates a total weight according to the first weight and the second weight. The sharpening circuit is coupled to the weighting circuit and performs an image sharpening process on the input image according to the total weight to generate an output image.

According to an embodiment of the present invention, the first adapter includes a processing unit and a weight generator. The processing unit receives the input image and generates a weighted information according to the first image property. The weight generator is coupled to the processing unit and generates the first weight according to the weighted information.

According to an embodiment of the present invention, the processing unit of the first adapter generates the weighted information according to the brightness values of a plurality of pixels of the input image, wherein the weighted information contains an average of the brightness values of at least two pixels adjacent to each of the pixels.

According to an embodiment of the present invention, the processing unit of the first adapter generates the weighted information according to the brightness values of a plurality of pixels of the input image, wherein the weighted information contains a difference between of brightness values at least two pixels adjacent to each of the pixels.

According to an embodiment of the present invention, the processing unit of the first adapter performs an averaging process according to the first image property to generate the weighted information.

According to an embodiment of the present invention, the processing unit of the first adapter generates the weighted information according to the chrominances of a plurality of pixels of the input image, wherein the weighted information contains a difference between the chrominances of at least two pixels adjacent to each of the pixels.

According to an embodiment of the present invention, the chrominance of each of the pixels includes a first chrominance and a second chrominance, and the processing unit of the first adapter generates the weighted information according to the first chrominance and/or the second chrominance of each of the pixels.

According to an embodiment of the present invention, the processing unit of the first adapter divides the pixels of the input image into a plurality of regions and generates the weighted information according to the first image property of the pixels in each of the regions.

According to an embodiment of the present invention, the weight decider multiplies the first weight by the second weight to generate the total weight.

According to an embodiment of the present invention, the weight decider selects one of the first weight and the second weight to generate the total weight.

According to an embodiment of the present invention, the sharpening circuit includes a first multiplier coupled to the weight decider. The first multiplier receives a gain and multiples the total weight by the gain to output a total gain. The sharpening circuit performs the image sharpening process on the input image according to the total gain to generate the output image.

According to an embodiment of the present invention, the sharpening circuit includes a high-pass filter, an image delayer, a second multiplier, and an adder. The high-pass filter receives the input image and performs a high-pass filtering process on the same to generate a high-frequency image. The image delayer receives the input image and delays the same to generate a delayed image. The second multiplier is coupled to the weighting circuit and the high-pass filter and multiplies the total gain by the high-frequency image to generate an accumulated image. The adder is coupled to the second multiplier and the image delayer and adds the accumulated image to the delayed image to generate the output image.

According to an embodiment of the present invention, the sharpening circuit includes a high-pass filter, an image delayer, a second multiplier, and an adder. The high-pass filter receives the input image and performs a high-pass filtering process on the same to generate a high-frequency image. The image delayer receives the input image and delays the same to generate a delayed image. The second multiplier is coupled to the weighting circuit and the high-pass filter and multiplies the total weight by the high-frequency image to generate an accumulated image. The adder is coupled to the second multiplier and the image delayer and adds the accumulated image to the delayed image to generate the output image.

The present invention provides an image processing method including following steps. First, an input image is received, and a plurality of weights is generated according to a plurality of image properties of a plurality of pixels in the input image. Then, a logical calculation is performed according to the weights to generate a total weight. Next, an image sharpening process is performed to the input image according to the total weight to generate an output image. Each of the weights is generated according to a corresponding image property among foregoing image properties.

According to an embodiment of the present invention, each of the weights is generated through following steps. First, a weighted information is generated according to the corresponding image property. Then, the weight is generated according to the weighted information.

According to an embodiment of the present invention, the weighted information is generated according to the brightness values of the pixels, wherein the weighted information contains an average of brightness values of at least two pixels adjacent to each of the pixels.

According to an embodiment of the present invention, the weighted information is generated according to the brightness values of the pixels, wherein the weighted information contains a difference between brightness values of at least two pixels adjacent to each of the pixels.

According to an embodiment of the present invention, the weighted information is generated by performing an averaging process according to the corresponding image property.

According to an embodiment of the present invention, the weighted information is generated according to the chrominances of the pixels, wherein the weighted information contains a difference between the chrominances of at least two pixels adjacent to each of the pixels.

According to an embodiment of the present invention, the chrominance of each of the pixels includes a first chrominance and/or a second chrominance, and the corresponding weighted information is generated according to the first chrominance and the second chrominance of each of the pixels.

According to an embodiment of the present invention, the corresponding weighted information is generated through following steps. First, the pixels are divided into a plurality of regions. Then, the corresponding weighted information is generated according to the image properties of the pixels in each of the regions.

According to an embodiment of the present invention, the total weight is generated by multiplying the weights.

According to an embodiment of the present invention, the total weight is generated by selecting one of the weights as the total weight.

According to an embodiment of the present invention, the step of performing the image sharpening process includes following steps. First, a gain is provided, and the total weight is multiplied by the gain to output a total gain. Then, the image sharpening process is performed on the input image according to the total gain to generate the output image.

According to an embodiment of the present invention, the step of performing the image sharpening process includes following steps. First, a high-pass filtering process is performed on the input image to generate a high-frequency image. Then, the input image is delayed to generate a delayed image. Next, the high-frequency image is multiplied by the total gain to generate an accumulated image. After that, the accumulated image is added to the delayed image to generate the output image.

According to an embodiment of the present invention, the step of performing the image sharpening process includes following steps. First, a high-pass filtering process is performed on the input image to generate a high-frequency image. Then, the input image is delayed to generate a delayed image. Next, the high-frequency image is multiplied by the total weight to generate an accumulated image. After that, the accumulated image is added to the delayed image to generate the output image.

The pixels of an input image have at least one image property. Each of the adapters respectively generates a weight according to one of the image properties of the pixels. A weight decider performs a logical calculation based on the weights generated by the adapters to generate a total weight. A sharpening circuit performs an image sharpening process on the input image according to the total weight. Thereby, the image processing circuit described above can sharpen an input image according to a plurality of weights regarding different image properties and generate an output image with improved visual effect.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of a conventional video signal processing apparatus.

FIGS. 2A-2E are timing diagrams of some signals of the video signal processing apparatus in FIG. 1.

FIG. 3 is a functional block diagram of an image processing circuit according to an embodiment of the present invention.

FIG. 4 is a functional block diagram of an adapter according to an embodiment of the present invention.

FIGS. 5A-5E are functional block diagrams of an adapter according to a plurality of embodiments of the present invention.

FIG. 6 is a diagram illustrating some pixels of an input image according to an embodiment of the present invention.

FIG. 7 is a diagram of a weight decider according to an embodiment of the present invention.

FIG. 8 is a diagram of a weight decider according to another embodiment of the present invention.

FIGS. 9-10 are respectively a functional block diagram of an image processing circuit according to an embodiment of the present invention.

FIG. 11 is a flowchart of an image processing method according to an embodiment of the present invention.

FIG. 12 is a flowchart for generating each weight according to an embodiment of the present invention.

FIGS. 13-14 are respectively a flowchart of an image sharpening process according to an embodiment of the present invention.

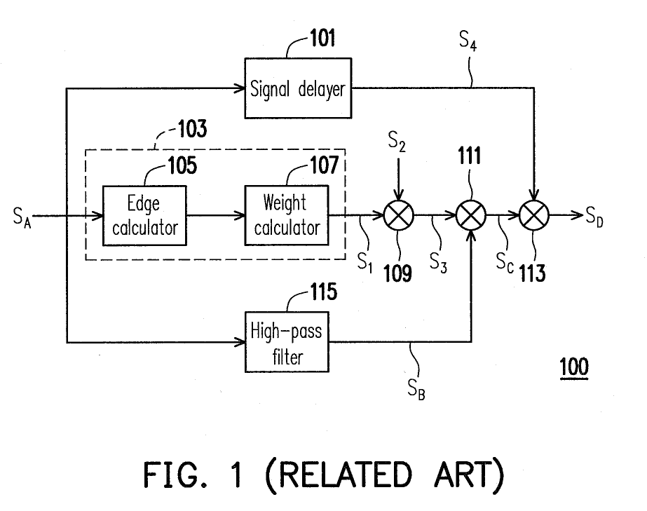

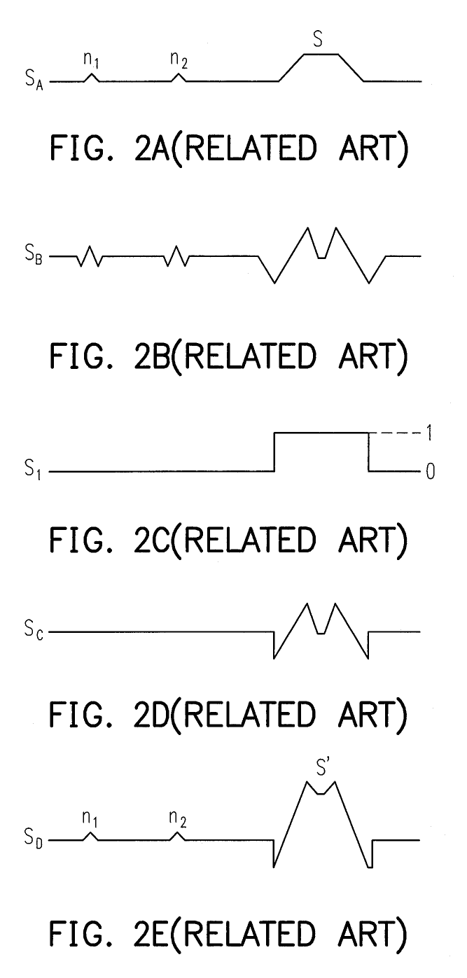

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

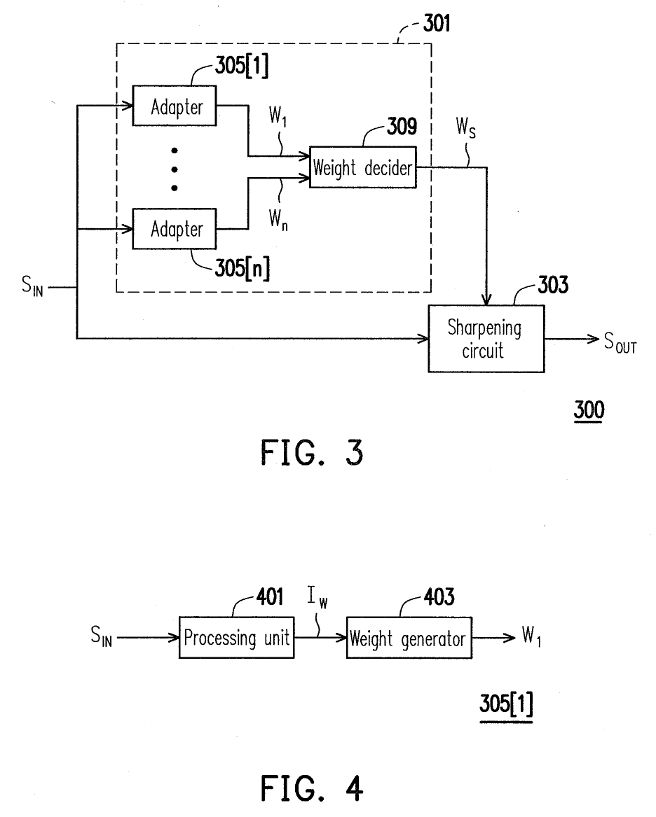

FIG. 3 is a functional block diagram of an image processing circuit according to an embodiment of the present invention. Referring to FIG. 3, the image processing circuit 300 sharpens an input image S_{IN} and generates an output image S_{OUT}. The input image S_{IN} has a plurality of pixels, and each of the pixels has a plurality of image properties, such as level, brightness, and chrominance. The image processing circuit 300 includes a weighting circuit 301 and a sharpening circuit 303. The weighting circuit 301 receives the input image S_{IN} and generates a total weight Wₛ according to at least one image property of the pixels of the input image S_{IN}. The sharpening circuit 303 is coupled to the weighting circuit 301 and performs an image sharpening process on the input image S_{IN} according to the total weight W_{S}, so as to generate the output image S_{OUT}.

The weighting circuit 301 includes adapters 305[1]-305[n] and a weight decider 309, wherein n is a positive integer greater than or equal to 2. Each adapter of the weighting circuit 301 receives the input image S_{IN} and generates a weight according to a corresponding image property among the image properties of the pixels. For example, the adapters 305[1]-305[n] receive the input image S_{IN} and respectively generate weights W₁-Wₙ according to the corresponding image properties. Those having ordinary knowledge in the art should be able to determine the number of the adapters adopted in the weighting circuit 301 according to the actual requirement based on the description of the present embodiment.

Each of the adapters 305[1]-305[n] includes a processing unit and a weight generator. FIG. 4 is a functional block diagram of the adapter 305[1] according to an embodiment of the present invention. Referring to FIG. 4, the adapter 305[1] includes a processing unit 401 and a weight generator 403. The processing unit 401 receives the input image S_{IN} and generates a weighted information I_{W} according to the corresponding image property. The weight generator 403 is coupled to the processing unit 401 and generates the corresponding weight W₁ according to the weighted information I_{W}.

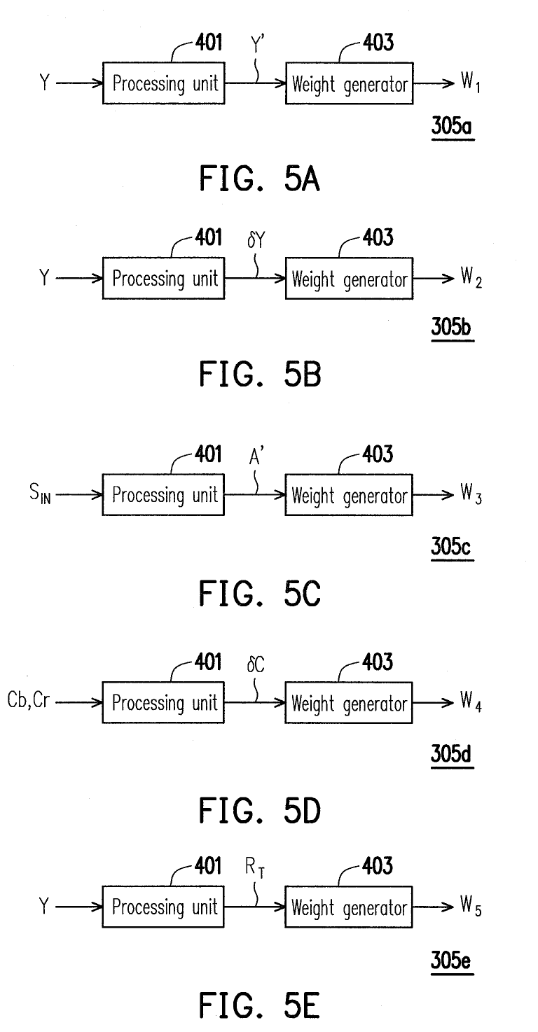

Various implementations of foregoing adapters will be described below. FIG. 5A is a functional block diagram of a first adapter 305a according to an embodiment of the present invention. Referring to FIG. 5A, the processing unit 401 of the adapter 305a generates the weighted information I_{W} according to the brightness values Y of the pixels, wherein the weighted information I_{W} contains an average Y′ of the brightness values of at least two pixels adjacent to each of the pixels.

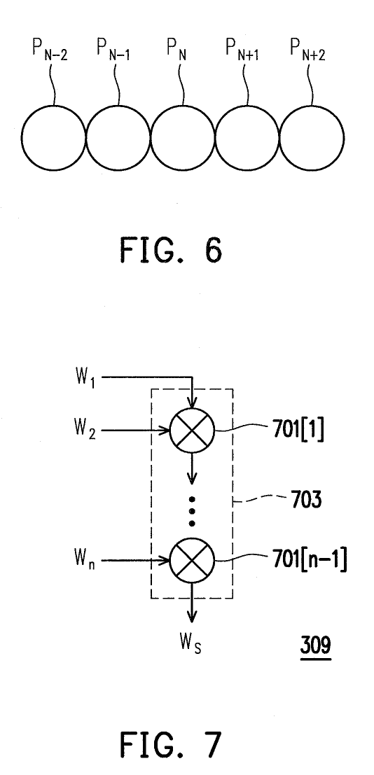

FIG. 6 is a diagram illustrating some pixels of the input image S_{IN} according to an embodiment of the present invention. Referring to both FIG. 6 and FIG. 5, P_{N-2}-P_{N+2} represent the pixels of the input image S_{IN} which are sequentially input into the processing unit 401, wherein P_{N} represents the current pixel. It is assumed herein that Y_{N-2}-Y_{N+2} respectively represent the brightness values of the pixels P_{N-2}-P_{N+2}. The processing unit 401 calculates an average Y′ of each pixel according to the brightness values of at least two pixels adjacent to this pixel. Taking the current pixel P_{N} as an example, the processing unit 401 selects the pixels P_{N-1} and P_{N+1} and calculates the average thereof as Y′=(Y_{N-1}+Y_{N+1})/2. In some embodiments, the processing unit 401 may also select the pixels P_{N-2}, P_{N-1}, P_{N+1}, and P_{N+2} and calculates the average thereof as Y′=(Y_{N-2}+Y_{N-1}+Y_{N+1}+Y_{N+2})/4 or select the pixels P_{N-2} and P_{N+2} and calculate the average thereof as Y′=(Y_{N-2}+Y_{N+2})/2.

FIG. 5B is a functional block diagram of a second adapter 305b according to an embodiment of the present invention. Referring to FIG. 5B, the processing unit 401 of the adapter 305b generates the weighted information I_{W} according to the brightness values Y of the pixels, wherein the weighted information I_{W} contains a brightness difference δY between at least two pixels adjacent to each of the pixels. Referring to both FIG. 5B and FIG. 6, taking the current pixel P_{N} as an example, the processing unit 401 selects the pixels P_{N-1} and P_{N+1} and calculates the brightness difference δY of the current pixel P_{N} as δY=|Y_{N-1}-Y_{N+1} | or selects the pixels P_{N-2} and P_{N+2} and calculates the brightness difference δY of the current pixel P_{N} as δY=|Y_{N-2}-Y_{N+2}|.

FIG. 5c is a functional block diagram of a third adapter 305c according to an embodiment of the present invention. Referring to FIG. 5c, the processing unit 401 of the adapter 305c performs an averaging process according to the corresponding image property to generate the weighted information I_{W}. Those having ordinary knowledge in the art should understand that the input image S_{IN} can be carried by an input image signal (not shown). In the present embodiment, the processing unit 401 performs a high-pass filtering process on the input image signal to generate a high-frequency image signal (not shown) and performs an averaging process on the amplitude A of the high-frequency image signal. The pixels of the input image S_{IN} have many different image properties (e.g. brightness, chrominance, etc), and the amplitude A of the high-frequency image signal is one of the image properties. Referring to FIG. 5C and FIG. 6, in the present embodiment, it is assumed that A(N−2)-A(N+2) are respectively the amplitudes of the pixels P_{N-2}-P_{N+2} corresponding to the high-frequency image signal, and the weighted information I_{W} contains an average amplitude A′ between at least two pixels adjacent to each of the pixels. Taking the current pixel P_{N} as an example, the processing unit 401 selects the pixels P_{N-1} and P_{N+1} and calculates the average amplitude as A′=(A_{N-1}+A_{N+1})/2 or selects the pixels P_{N-2} and P_{N+2} and calculates the average amplitude as A′=(A_{N-2}+A_{N+2})/2.

FIG. 5D is a functional block diagram of a fourth adapter 305d according to an embodiment of the present invention. Referring to FIG. 5D, the processing unit 401 of the adapter 305d generates the weighted information I_{W} according to the chrominances of the pixels, wherein the weighted information I_{W} contains a difference δC between the chrominances of at least two pixels adjacent to each of the pixels. The chrominance of each pixel includes a first chrominance Cb and a second chrominance Cr. Referring to FIG. 5D and FIG. 6, Cb(N−2)-Cb(N+2) respectively represent the first chrominances of the pixels P_{N-2}-P_{N+2}, and Cr(N−2)-Cr(N+2) respectively represent the second chrominances of the pixels P_{N-2}-P_{N+2}. Taking the current pixel P_{N} as an example, the processing unit 401 selects the first chrominances of the pixels P_{N-1} and P_{N+1} to calculate the difference as δC=|Cb(N−1)-Cb(N+1)| or selects the second chrominances of the pixels P_{N-1} and P_{N+1} to calculate the difference as δC=|Cr(N−1)-Cr(N+1)|. Or, the processing unit 401 may also select the first chrominance and the second chrominances of the pixels P_{N-1} and P_{N+1} to calculate the difference as

$$δ C = \sqrt{{( Cb ( N + 1 ) - Cb ( N - 1 ) )}^{2} + {( Cr ( N + 1 ) - Cr ( N - 1 ) )}^{2}} .$$

Besides, in some embodiments, the processing unit 401 may also select the first chrominances of the pixels P_{N-2} and P_{N+2} to calculate the difference as δC=|Cb(N−2)-Cb(N+2)|, select the second chrominances of the pixels P_{N-2} and P_{N+2} to calculate the difference as δC=|Cr(N−2)-Cr(N+2)|, or select the first chrominances and the second chrominances of the pixels P_{N-2} and P_{N+2} to calculate the difference as

$$δ C = \sqrt{{( Cb ( N + 2 ) - Cb ( N - 2 ) )}^{2} + {( Cr ( N + 2 ) - Cr ( N - 2 ) )}^{2}} .$$

FIG. 5E is a functional block diagram of a fifth adapter 305e according to an embodiment of the present invention. Referring to FIG. 5E, the processing unit 401 of the adapter 305e divides the pixels of the input image S_{IN} into a plurality of regions and performs a region classifying process on each of the regions to generate the weighted information I_{W}. The processing unit 401 can determine the type of a region according to the color information (for example, the brightness values Y) of all or most pixels in the region or by comparing the region with adjacent regions. For example, after the processing unit 401 performs the region classifying process on a region and announces that the region is a flat region, it means the brightness values Y of the pixels in this region does not show much difference. Contrarily, when the processing unit 401 announces a region as an edge region, it means the pixels in this region are located at an edge of the input image S_{IN}. In the present embodiment, the processing unit 401 assigns different region codes R_{T} to different types of regions (for example, 0 to a flat region and 7 to an edge region), and the weighted information I_{W} contains the region code R_{T} corresponding to each region. However, the present invention is not limited thereto.

Referring to FIG. 4, in the present embodiment, the weight generator 403 obtains the corresponding weight W₁ from a look-up table according to the weighted information I_{W} and outputs the weight W₁. Besides, even though the adapter 305[1] is described in the present embodiment as an example, those having ordinary knowledge in the art should be able to implement the other adapters of the weighting circuit 301 similarly to obtain the corresponding weights from the look-up table according to the weighted information I_{W} thereof and output the same. For example, the corresponding weight Wₙ of an adapter 305[n] can be obtained from the look-up table according to the weighted information I_{W} thereof.

Referring to FIG. 3 again, the weight decider 309 is coupled to the adapters 305[1]-305[n] for receiving the weights W₁-Wₙ. The weight decider 309 performs a logical calculation based on the weights W₁-Wₙ to generate a total weight W_{S}. In the present embodiment, the weight decider 309 multiplies the weights W₁-Wₙ generated by the adapters 305[1]-305[n] to generate the total weight W_{S}. Or, the weight decider 309 may also select one of the weights W₁-Wₙ generated by the adapters 305[1]-305[n] as the total weight W_{S}. FIG. 7 is a diagram of the weight decider 309 according to an embodiment of the present invention. Referring to FIG. 7, the weight decider 309 includes multipliers 701[1]-701[n−1]. The multipliers 701[1]-701[n−1] are connected with each other in series to form a multiplier 703 with multiple inputs. The multiplier 703 receives the weights W₁-Wₙ respectively through the multiple inputs thereof and multiplies the weights W₁-Wₙ to generate the total weight W_{S}. In other words, the total weight W_{S} is related to all the weights W₁-Wₙ and is not affected by a single weight very much.

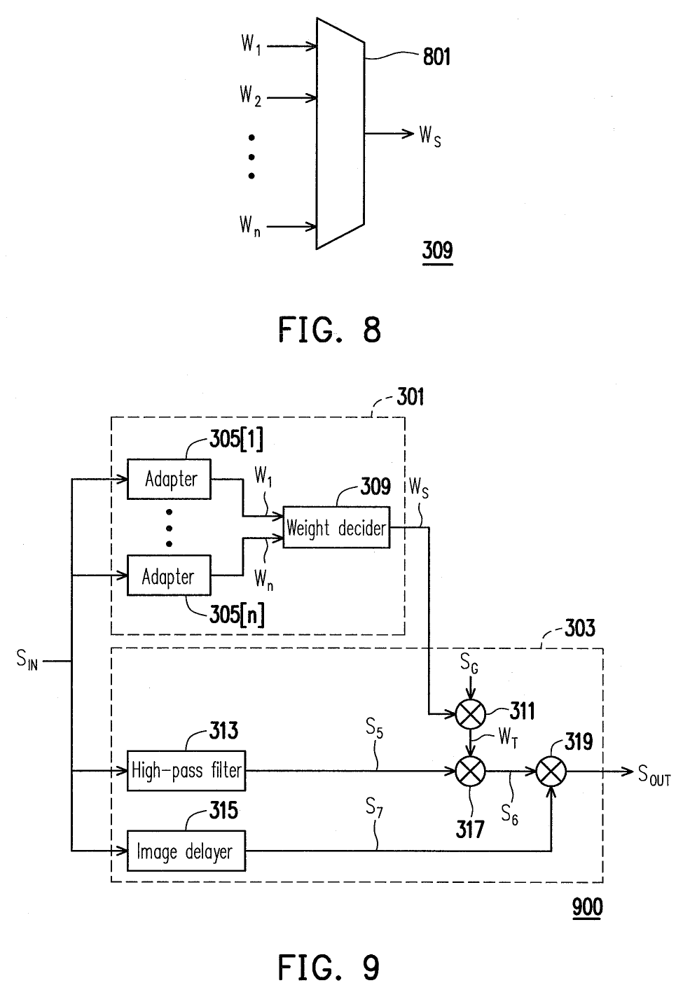

FIG. 8 is a diagram of the weight decider 309 according to another embodiment of the present invention. Referring to FIG. 8, the weight decider 309 includes a selector 801. The selector 801 has at least n input terminals for respectively receiving the weights W₁-Wₙ. The selector 801 selects one of the weights as the total weight W_{S} according to a predetermined selection mechanism. In the present embodiment, the selector 801 selects the smallest weight as the total weight W_{S}. However, the present invention is not limited thereto.

Generally speaking, the weights W₁-Wₙ output by the adapters 305[1]-305[n] are within the range of 0 to 1. However, if the input image S_{IN} is to be sharpened especially regarding a specific image property, the weight output range of the corresponding adapter can be adjusted to accomplish this purpose. This will be described herein by taking the adapter 305[1] and the adapter 305[n] as examples. It is assumed that the adapter 305[1] generates the weight W₁ according to the brightness values of the pixels of the input image S_{IN}, the adapter 305[n] performs a high-pass filtering process and an averaging process on the input image S_{IN} to generate the weight Wₙ, and the weight decider 309 performs a logical calculation according to the weights W₁ and Wₙ to generate the total weight W_{S}. If the input image S_{IN} is to be sharpened especially regarding the image property corresponding to the adapter 305[n], the output range of the weight Wₙ generated by the adapter 305[n] is adjusted to 0 to 2. It should be noted that when the weight decider 309 is implemented as in FIG. 7, because the weights W₁-Wₙ output by the adapters 305[1]-305[n] are multiplied to obtain the total weight W_{S}, the adjusted weight Wₙ (0 to 2) takes up a larger proportion and accordingly affects the total weight W_{S} to a greater extent. In addition, when the weight decider 309 is implemented as illustrated in FIG. 8, the selection mechanism of the selector 801 can be correspondingly changed regarding the situation that the weight is greater than 1, so as to determine whether to select the weight greater than 1 first.

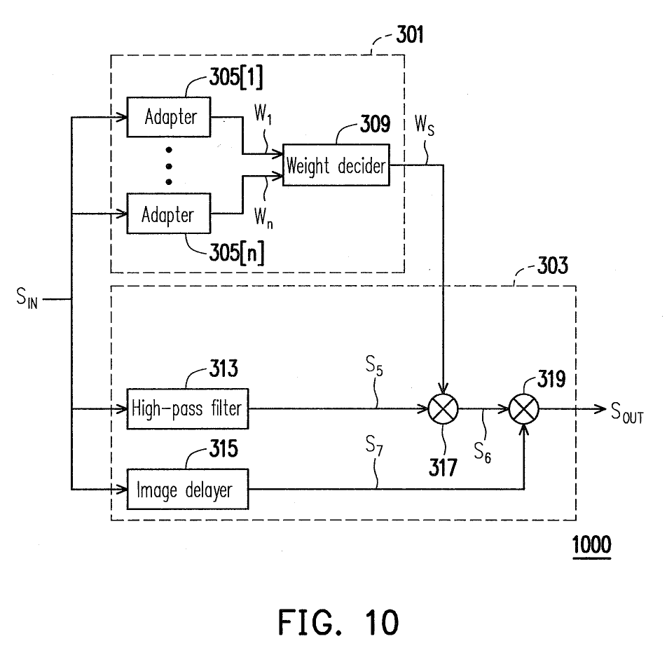

FIG. 9 is a functional block diagram of an image processing circuit 900 according to an embodiment of the present invention. Referring to FIG. 9, the image processing circuit 900 includes a weighting circuit 301 and a sharpening circuit 303. The weighting circuit 301 of the image processing circuit 900 is the same as the weighting circuit 301 of the image processing circuit 300 illustrated in FIG. 3, therefore only the sharpening circuit 303 of the image processing circuit 900 will be described herein. The sharpening circuit 303 includes a first multiplier 311, a high-pass filter 313, an image delayer 315, a second multiplier 317, and an adder 319. The first multiplier 311 is coupled to the weight decider 309 for receiving the total weight W_{S}. The first multiplier 311 multiplies the total weight W_{S} by a gain S_{G} to generate a total gain W_{T}.

The high-pass filter 313 receives the input image S_{IN} and performs a high-pass filtering process on the same to generate a high-frequency image S₅. The second multiplier 317 is coupled to the first multiplier 311 and the high-pass filter 313 for respectively receiving the total gain W_{T} and the high-frequency image S₅, and the second multiplier 317 multiplies the high-frequency image S₅ by the total gain W_{T} to generate an accumulated image S₆. Meanwhile, the image delayer 315 receives the input image S_{IN} and delays the same to output a delayed image S₇. The adder 319 is coupled to the second multiplier 317 and the image delayer 315 for respectively receiving the accumulated image S₆ and the delayed image S₇, and the adder 319 adds the accumulated image S₆ to the delayed image S₇ to generate an output image S_{OUT}.

FIG. 10 is a functional block diagram of an image processing circuit 1000 according to another embodiment of the present invention. Referring to FIG. 9 and FIG. 10, the image processing circuit 1000 is similar to the image processing circuit 300, and only the difference between the two will be described herein. Referring to FIG. 10, the sharpening circuit 303 includes a high-pass filter 313, an image delayer 315, a second multiplier 317, and an adder 319. The second multiplier 317 is coupled to the weight decider 309 and the high-pass filter 313 for respectively receiving a total weight W_{S} and a high-frequency image S₅, and the second multiplier 317 multiplies the high-frequency image S₅ by the total weight W_{S} to generate an accumulated image S₆. The adder 319 adds the accumulated image S₆ to the delayed image S₇ to generate an output image S_{OUT}.

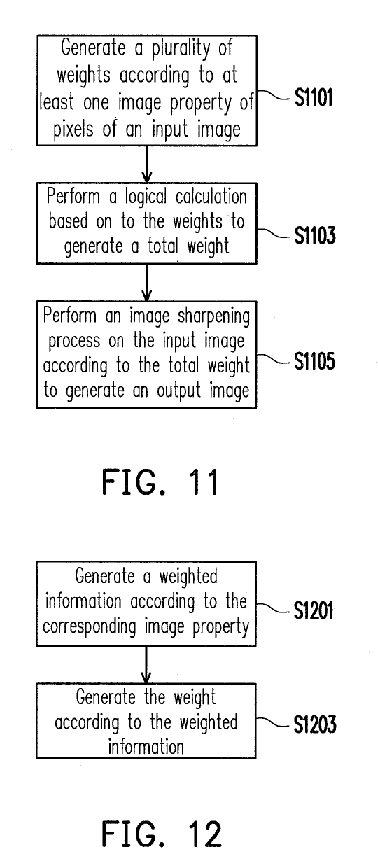

An image processing method will be described below based on the embodiments described above. FIG. 11 is a flowchart of the image processing method according to an embodiment of the present invention. Referring to both FIG. 11 and FIG. 3, in step S1101, the adapters 305[1]-305[n] receive the input image S_{IN} and generate a plurality of weights W₁-Wₙ according to at least one image property of a plurality of pixels of the input image S_{IN}. In the present embodiment, the input image S_{IN} has a plurality of pixels, each of the pixels has a plurality of image properties (e.g. level, brightness, chrominance, etc), and each of the weights is generated according to at least one image property. In step S1103, the weight decider 309 performs a logical calculation according to the weights W₁-Wₙ to generate the total weight W_{S}. In step S1105, the sharpening circuit 303 performs an image sharpening process on the input image S_{IN} according to the total weight W_{S} to generate the output image S_{OUT}.

In foregoing step S1101, each of the weights is generated through following steps. FIG. 12 is a flowchart for generating each weight according to an embodiment of the present invention. Referring to both FIG. 12 and FIG. 4, in step S1201, the processing unit 401 generates a weighted information I_{W} according to the corresponding image property. In step S1203, the weight generator 403 generates a weight W₁ according to the weighted information I_{W}. For example, the weight generator 403 obtains the corresponding weight from a look-up table according to the weighted information I_{W}.

Different methods for generating the weighted information I_{W} in step S1201 will be described herein so that those having ordinary knowledge in the art can implement this step accordingly. However, the present invention is not limited to these implementations. For example, the corresponding weighted information I_{W} can be generated according to the brightness values Y of the pixels of the input image S_{IN}, wherein the weighted information I_{W} contains an average Y′ (as shown in FIG. 5A) or a brightness difference δY (as shown in FIG. 5B) of at least two pixels adjacent to each of the pixels.

In addition, an averaging process may be performed according to the corresponding image property to generate the corresponding weighted information I_{W}. For example, as shown in FIG. 5C, the processing unit 401 performs a high-pass filtering process on the input image S_{IN} to generate a high-frequency image (not shown), and the processing unit 401 calculates an average A′ of the differences of at least two pixels adjacent to each of the pixels in the high-frequency image as the weighted information I_{W}.

Or, the processing unit 401 may generate the corresponding weighted information I_{W} according to the chrominances of the pixels of the input image S_{IN}, wherein the weighted information I_{W} contains a difference δC between the chrominances of at least two pixels adjacent to each of the pixels, as shown in FIG. 5D. In the present embodiment, the chrominances of each pixel includes a first chrominance Cb and a second chrominance Cr, and the difference δC may be a difference between the first chrominances, a difference between the second chrominances, or a difference between the first chrominances and the second chrominances.

In some embodiments, as shown in FIG. 5E, the processing unit 401 divides the pixels of the input image S_{IN} into a plurality of regions and then generates the corresponding weighted information I_{W} according to the image properties of the pixels within each of the regions.

Referring to both FIG. 7 and FIG. 11, in step S1103, the total weight W_{S} may be generated through following steps. The weight decider 309 generates the total weight W_{S} by multiplying the weights W₁-Wₙ generated in step S1101. Or, as shown in FIG. 8 and FIG. 11, the weight decider 309 generates the total weight W_{S} according to a selection mechanism, wherein the weight decider 309 selects one of the weights W₁-Wₙ (for example, the smallest weight) generated in step S1101 as the total weight W_{S}.

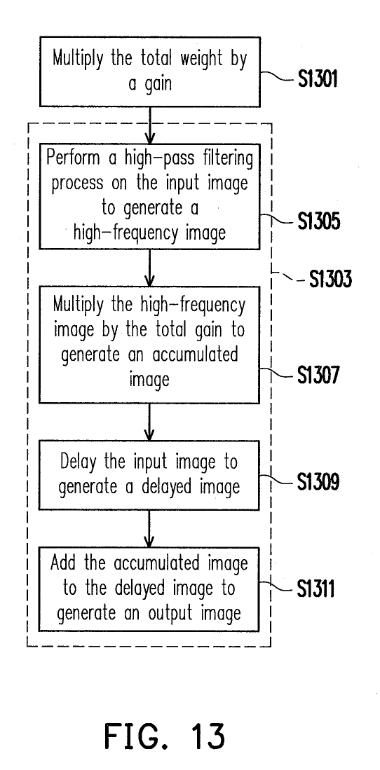

The step S1105 of performing the image sharpening process may be implemented through following steps. FIG. 13 is a flowchart of an image sharpening process according to an embodiment of the present invention. Referring to both FIG. 9 and FIG. 13, in step S1301, a gain S_{G} is provided. The first multiplier 311 multiplies the total weight W_{S} by the gain S_{G} to output a total gain S_{T}. In step S1303, the sharpening circuit 303 performs an image sharpening process on the input image S_{IN} according to the total gain S_{T}, so as to generate the output image S_{OUT}. Step S1303 further includes steps S1305 to S1311. In step S1305, the high-pass filter 313 performs a high-pass filtering process on the input image S_{IN} to generate a high-frequency image S₅. In step S1307, the second multiplier 317 multiplies the high-frequency image S₅ by the total gain S_{T} to generate an accumulated image S₆. In step S1309, the image delayer 315 delays the input image S_{IN} to generate a delayed image S₇. In step S1311, the adder 319 adds the accumulated image S₆ to the delayed image S₇ to generate the output image S_{OUT}.

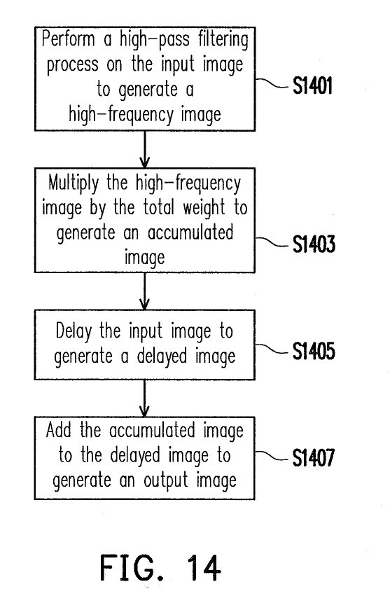

FIG. 14 illustrates another implementation of foregoing step S1105. Referring to both FIG. 10 and FIG. 14, in the present embodiment, the step S1105 further includes steps S1401 to S1407. In step S1401, the high-pass filter 313 performs a high-pass filtering process on the input image S_{IN} to generate a high-frequency image S₅. In step S1403, the second multiplier 317 multiplies the high-frequency image S₅ by the total weight W_{S} to generate an accumulated image S₆. In step S1405, the image delayer 315 delays the input image to generate a delayed image S₇. In step S1407, the adder adds the accumulated image S₆ to the delayed image S₇ to generate the output image S_{OUT}.

As described above, in the embodiments described above, the adapters 305[1] to 305[n] respectively generate the weights W₁-Wₙ according to the corresponding image properties. The weight decider 309 performs a logical calculation based on the weights W₁-Wₙ to generate a total weight W_{S}, and the input image is appropriately sharpened according to the total weight W_{S}. The adapters 305[1]-305[n] may generate the weights W₁-Wₙ according to the same or different image properties through different calculation methods. Thus, the weight decider 309 multiplies the weights W₁-Wₙ to integrate different image information. Or, the weight decider 309 may also select the smallest weight among the weights W₁-Wₙ as the total weight W_{S} for sharpening the image. The sharpening circuit 303 performs an image sharpening process on the input image S_{IN} according to the total weight W_{S}, so as to generates the output image S_{OUT}.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image processing circuit, comprising:
a weighting circuit, comprising:
a first adapter, for receiving an input image and generating a first weight according to a first image property of the input image;
a second adapter, for receiving the input image and generating a second weight according to a second image property of the input image; and
a weight decider, coupled to the first adapter and the second adapter, for generating a total weight according to the first weight and the second weight; and
a sharpening circuit, coupled to the weighting circuit, for performing an image sharpening process on the input image according to the total weight to generate an output image.

2. The image processing circuit according to claim 1, wherein the first adapter comprises:
a processing unit, for receiving the input image and generating a weighted information according to the first image property; and
a weight generator, coupled to the processing unit, for generating the first weight according to the weighted information.

3. The image processing circuit according to claim 2, wherein the processing unit of the first adapter generates the weighted information according to brightness values of a plurality of pixels of the input image, and the weighted information comprises an average of brightness values of at least two pixels adjacent to each of the pixels.

4. The image processing circuit according to claim 2, wherein the processing unit of the first adapter generates the weighted information according to brightness values of a plurality of pixels of the input image, and the weighted information comprises a difference between brightness values of at least two pixels adjacent to each of the pixels.

5. The image processing circuit according to claim 2, wherein the processing unit of the first adapter performs an averaging process according to the first image property to generate the weighted information.

6. The image processing circuit according to claim 2, wherein the processing unit of the first adapter generates the weighted information according to chrominances of a plurality of pixels of the input image, and the weighted information comprises a difference between the chrominances of at least two pixels adjacent to each of the pixels.

7. The image processing circuit according to claim 6, wherein the chrominance of each of the pixels comprises a first chrominance and a second chrominance, and the processing unit of the first adapter generates the weighted information according to the first chrominance and/or the second chrominance of each of the pixels.

8. The image processing circuit according to claim 2, wherein the processing unit of the first adapter divides a plurality of pixels of the input image into a plurality of regions and generates the weighted information according to the first image property of the pixels in each of the regions.

9. The image processing circuit according to claim 1, wherein the weight decider multiplies the first weight by the second weight to generate the total weight.

10. The image processing circuit according to claim 1, wherein the weight decider selects one of the first weight and the second weight to generate the total weight.

11. The image processing circuit according to claim 1, wherein the sharpening circuit comprises:
a first multiplier, coupled to the weight decider, for receiving a gain and multiplying the total weight by the gain to output a total gain, wherein the sharpening circuit performs the image sharpening process on the input image according to the total gain to generate the output image.

12. The image processing circuit according to claim 11, wherein the sharpening circuit comprises:
a high-pass filter, for receiving the input image and performing a high-pass filtering process on the input image to generate a high-frequency image;
an image delayer, for receiving the input image and delaying the input image to generate a delayed image;
a second multiplier, coupled to the weighting circuit and the high-pass filter, for multiplying the high-frequency image by the total gain to generate an accumulated image; and
an adder, coupled to the second multiplier and the image delayer, for adding the accumulated image to the delayed image to generate the output image.

13. The image processing circuit according to claim 1, wherein the sharpening circuit comprises:
a high-pass filter, for receiving the input image and performing a high-pass filtering process on the input image to generate a high-frequency image;
an image delayer, for receiving the input image and delaying the input image to generate a delayed image;
a second multiplier, coupled to the weighting circuit and the high-pass filter, for multiplying the high-frequency image by the total weight to generate an accumulated image; and
an adder, coupled to the second multiplier and the image delayer, for adding the accumulated image to the delayed image to generate the output image.

14. An image processing method, comprising:
receiving an input image, and generating a plurality of weights according to a plurality of image properties of a plurality of pixels in the input image;
performing a logical calculation according to the weights to generate a total weight; and
performing an image sharpening process on the input image according to the total weight to generate an output image,
wherein each of the weights is generated according to a corresponding image property among the image properties.

15. The image processing method according to claim 14, wherein each of the weights is generated through following steps:
generating a weighted information according to the corresponding image property; and
generating the weight according to the weighted information.

16. The image processing method according to claim 15, wherein the step of generating the weighted information comprises:
generating the corresponding weighted information according to brightness values of the pixels, wherein the weighted information comprises an average of brightness values between at least two pixels adjacent to each of the pixels.

17. The image processing method according to claim 15, wherein the step of generating the corresponding weighted information comprises:
generating the corresponding weighted information according to brightness values of the pixels, wherein the weighted information comprises a difference between brightness values of at least two pixels adjacent to each of the pixels.

18. The image processing method according to claim 15, wherein the step of generating the corresponding weighted information comprises:
performing an averaging process according to the corresponding image property to generate the corresponding weighted information.

19. The image processing method according to claim 15, wherein the step of generating the corresponding weighted information comprises:
generating the corresponding weighted information according to chrominances of the pixels, wherein the weighted information comprises a difference between the chrominances of at least two pixels adjacent to each of the pixels.

20. The image processing method according to claim 19, wherein a chrominance of each of the pixels comprises a first chrominance and a second chrominance, and the corresponding weighted information is generated according to the first chrominance and/or the second chrominance of each of the pixels.

21. The image processing method according to claim 15, wherein the step of generating the corresponding weighted information comprises:
dividing the pixels into a plurality of regions; and
generating the corresponding weighted information according to the image properties of the pixels in each of the regions.

22. The image processing method according to claim 15, wherein the total weight is generated by multiplying the weights.

23. The image processing method according to claim 15, wherein the total weight is generated by selecting one of the weights as the total weight.

24. The image processing method according to claim 14, wherein the step of performing the image sharpening process comprises:
providing a gain, and multiplying the total weight by the gain to output a total gain; and
performing the image sharpening process on the input image according to the total gain to generate the output image.

25. The image processing method according to claim 24, wherein the step of performing the image sharpening process comprises:
performing a high-pass filtering process on the input image to generate a high-frequency image;
delaying the input image to generate a delayed image;
multiplying the high-frequency image by the total gain to generate an accumulated image; and
adding the accumulated image to the delayed image to generate the output image.

26. The image processing method according to claim 14, wherein the step of performing the image sharpening process comprises:
performing a high-pass filtering process on the input image to generate a high-frequency image;
delaying the input image to generate a delayed image;
multiplying the high-frequency image by the total weight to generate an accumulated image; and
adding the accumulated image to the delayed image to generate the output image.
